(19) United States
(12) Patent Application Publication
(10) Pub. No.: US 2016/0192218 A1
(43) Pub. Date: Jun. 30, 2016

(54) TECHNIQUES FOR CLASSIFYING SLEEP SESSIONS

(71) Applicant: Under Armour, Inc., Baltimore, MD (US)

(72) Inventor: Christopher Peters, Baltimore, MD (US)

(21) Appl. No.: 14/798,585

(22) Filed: Jul. 14, 2015

Related U.S. Application Data
(60) Provisional application No. 62/024,108, filed on Jul. 14, 2014.

(51) Int. Cl. H04W 24/08; H04W 76/04

(52) U.S. Cl. CPC H04W 24/08; H04W 76/046

(57) ABSTRACT

Techniques are provided herein for categorizing and classifying sleep session data. A server device receives sleep data from a sleep monitoring device. The sleep data comprises information that is indicative of sleep patterns of a user over a period of time. After receiving the sleep data, the server analyzes the information to determine a starting time instance and a stopping time instance to define a sleep session over the period of time. The server associates the starting time instance to a first calendar time instance and associates the stopping time instance to a second time instance. The server classifies the sleep session as belonging to a calendar day associated with the second calendar time instance.

### RELATED APPLICATIONS

This application claims priority from U.S. Provisional Patent Application No. 62/024,108 filed on Jul. 14, 2014, the entirety of which is incorporated by reference herein.

### TECHNICAL FIELD

The present disclosure relates to techniques for categorizing and classifying sleep session data.

### BACKGROUND OF THE INVENTION

Sleep quality is considered to have lasting health effects. For example, high quality sleep for sustained durations may increase an individual's overall health and well-being. Likewise, poor quality sleep may have adverse health effects on an individual. Due to the effects of sleep quality on overall health, many health professionals and fitness advocates consider sleep quality as a crucial component of an individual's overall fitness profile. Accordingly, sleep data is often evaluated as a part of a comprehensive fitness evaluation. Sleep data may be measured in laboratories and/or by personal electronic devices that affix to an individual's person over the course of a day. In one example, fitness devices are configured to track biometric data of an individual during an active portion of an individual's day (e.g., data such as steps taken, heart rate, pulse count, exercise intensity) and are also configured to track biometric data during a passive portion of an individual's day (e.g., sleep data, resting heart rate, etc.).

### BRIEF DESCRIPTION OF THE DRAWINGS

FIG. 1 shows an example system topology depicting a server configured to classify sleep data obtained from a monitoring device and/or data display device, according to an example embodiment.

FIGS. 2A-2D show example diagrams representing sleep session durations detected and classified by the server over a period of time, according to an example embodiment.

FIG. 3 shows an example flow chart depicting operations of the server classifying sleep data, according to an example embodiment.

FIG. 4 shows another example flow chart depicting operations of the server classifying the sleep data.

FIG. 5 shows an example block diagram depicting the server configured to classify the sleep session data, according to an example embodiment.

FIG. 6 shows an example block diagram of a monitoring device configured to perform sleep session detection operations, according to an example embodiment.

FIG. 7 shows an example block diagram of a display device configured to present sleep data to a user, according to an example embodiment.

### DETAILED DESCRIPTION OF EXAMPLE EMBODIMENTS

### Overview

Techniques are described herein for categorizing and classifying sleep session data. A server device receives sleep data from a sleep monitoring device. The sleep data comprises information that is indicative of sleep patterns of a user over a period of time. After receiving the sleep data, the server analyzes the information to determine a starting time instance and a stopping time instance to define a sleep session over the period of time. The server associates the starting time instance to a first calendar time instance and associates the stopping time instance to a second time instance. The server classifies the sleep session as belonging to a calendar day associated with the second calendar time instance.

### Example Embodiments

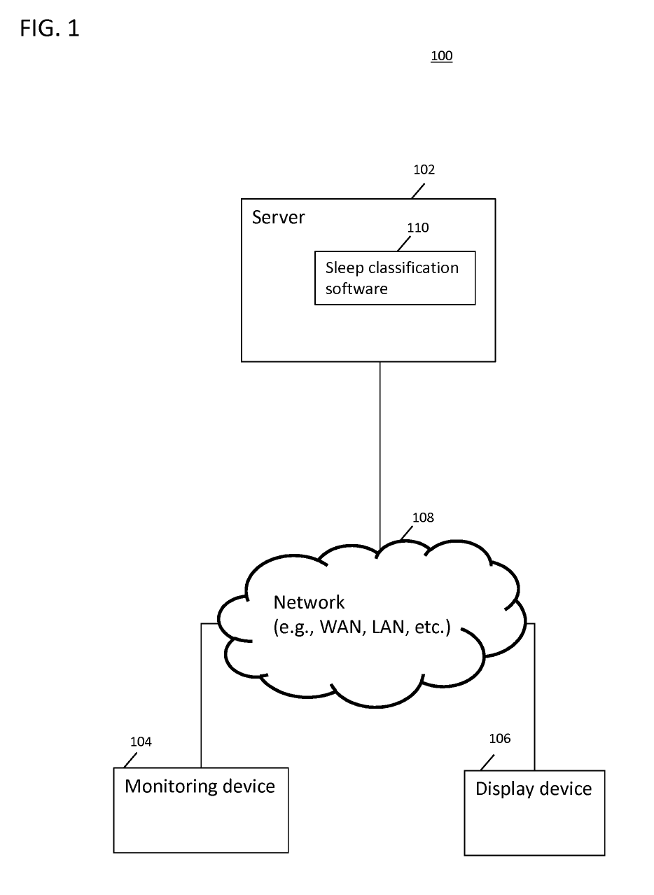

The techniques presented herein relate to categorizing and classifying sleep session data obtained by one or more devices in a network. An example system topology (“system”) is shown at reference numeral 100 in FIG. 1. The system 100 comprises a server device (“server”) 102, a monitoring device 104 and a display device 106. The server 102, monitoring device 104 and display device 106 are configured to communicate with each other via the network 108. The network 108 may be, for example, a Wide Area Network (WAN) (e.g., the Internet), a Local Area Network (LAN), a Personal Area Network (PAN), etc. In one example, the server 102, monitoring device 104 and display device 106 are configured to send and receive communications (e.g., data packets) to each other via the network 108. As described by the techniques herein, the monitoring device 104 and/or the display device 106 may be configured to send sleep data to the server 102. The sleep data may comprise information that is indicative of sleep patterns of a user (not shown in FIG. 1) over a period of time. Likewise, in one example, the server 102 is configured to send to the monitoring device 104 and/or the display device 106 communications (messages) with presentation instructions. In one example, the presentation instructions cause the monitoring device 104 and/or the display device 106 to display to a user the sleep data according to the classifications determined by the server 102. The techniques are described in more detail hereinafter.

In general, the server 102 is a network device that is configured to send and receive communications in the system 100 (e.g., via the network 108). The server 102 may be a computing device configured to send and receive data from a plurality of devices over the network 108, and in one example, the server 102 may be a mobile device (e.g., a network enabled phone or “smart phone”). The server 102 may process packets received by other devices in the system 100 and may store executable software (e.g., computer/processor executable logic) to classify data received by the other devices in the system 100. For example, as described herein, the server 102 may store sleep classification software 110 to analyze, categorize and classify sleep data received by the monitoring device 104 and/or the display device 106 over the network 108 and to send to the monitoring device 104 and/or the display device 106 presentation instruction messages to display to a user sleep data according to the analysis, classifications and categorizations determined by the server 102. In one example, the server 102 is a computing device configured to perform the sleep session data categorization and classification techniques described herein.

The monitoring device 104 is a device configured to record sleep session data. For example, the monitoring device 104 may be a device that is capable of being affixed to a user over the course of a day or multiple days to monitor and collect biometric data of the user. The monitoring device 104 may be a heart rate monitor, pedometer, activity tracking device, mobile phone, or any fitness device that is configured to collect biometric data, including, but not limited to, information related to a user's sleep activity and/or exercise activity. In one example, the monitoring device 104 may be a wireless device that is configured to exchange in real time or substantially real time data related to a user's sleep activity and/or exercise activity over a wireless connection to the network 108. In another example, the monitoring device 104 may be configured to send to the server 102 data related to the user's sleep activity and/or exercise activity at periodic or designated instances over a connection (wireless or wired) to the network 108. Thus, in general, the monitoring device 104 is computing device configured to exchange sleep data information to the server 102 via the network 108. Though not shown in FIG. 1, it should be appreciated that operations of the server 102 may occur on the monitoring device 104. That is, in one example, the monitoring device 104 may perform the server 102 operations described herein. For simplicity, FIG. 1, and the descriptions here show the server 102 and the monitoring device 104 as separate devices, but it should be appreciated that any operations described in connection with the server 102 and the monitoring device 104 may occur on separate devices or may occur on the same device (e.g., a mobile device such as a mobile phone, tablet, laptop computer, etc.).

The display device 106 is a device configured to display biometric data (including sleep data) at the instruction of the server 102. For example, the display device 106 may be a computer, laptop, desktop, mobile phone, tablet, etc. that is configured to connect to the network 108 (via a wired or wireless connection) to receive from the server 102 display instructions. The display device 102 may be a mobile device (e.g., a network enabled phone such as a “smartphone”) that displays to the user of the display device 102 information related to the user's sleep patterns and/or exercise patterns. In one example, the display device 106 may perform identical functions as the monitoring device 104, and likewise, the monitoring device 104 may perform identical functions as the display device 106. Thus, the functionalities of the monitoring device 104 and the display device 106 may be enabled in one device in communication with the server 102 over the network 108 or in multiple devices in communication with the server 102 over the network 108. For simplicity, FIG. 1 shows the system 100 comprising the monitoring device 104 and the display device 106 as separate devices. It should be appreciated that the operations described for each devices may exist or be operational/executable in one network device. It should be further appreciated that the monitoring device 104 and the display device 106 may communicate with each other via the network 108 or another network not shown in FIG. 1 (e.g., to exchange biometric data and other information with each other).

Thus, FIG. 1 shows the system 100 wherein the server 102 is configured to receive messages from the monitoring device 104 and/or the display device 106 and to analyze and categorize the information. For example, as stated above, the monitoring device 104 may send to the server 102 sleep data related to a user, and the server 102 may analyze the sleep data to determine which “day” (e.g., which calendar day) to categorize the sleep data information. As will become apparent hereinafter, sleep data for a given sleep session may be collected over a time period or time instances that span a single calendar day (e.g., sleep data for a sleep session that starts and ends on the same calendar day) or that span a plurality of days (e.g., sleep data for a sleep session that starts in one calendar day and ends on another calendar day). For example, a user may begin a sleep session before midnight on one calendar day and may end a sleep session after midnight on the next calendar day. Likewise, a user may nap or initiate multiple sleep sessions, some of which may straddle more than one calendar day, and some of which may be limited to occurring in a single calendar day. The server 102 analyzes the sleep data received from the monitoring device 104 and categorizes/classifies the day on which a sleep session associated with the sleep data occurred. Such analysis and categorization by the server 102 improves the functioning of both the server 102 and the monitoring device 104 since it is able to effectively categorize sleep sessions as belonging to the right calendar day, particularly when the sleep session begins in one day and ends in another day. Furthermore, devices that utilize the sleep data analysis and categorization techniques described herein to classify and categorize sleep sessions into appropriate calendar days can operate more efficiently to indicate to the user sleep information over a day or series of days. These techniques are described herein.

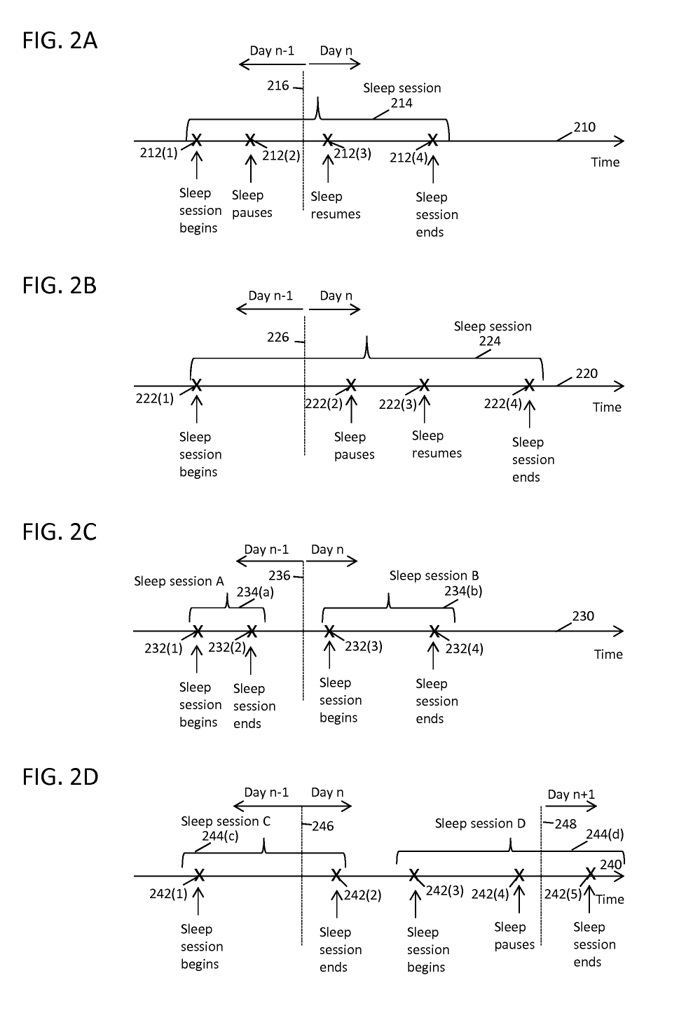

Reference is now made to FIGS. 2A-2D. FIGS. 2A-2D show example diagrams representing sleep session durations detected and classified by the server 102 over a period of time. FIGS. 2A-2D show sleep events at various points in time. The sleep events are designated by the “x” marks on the timelines shown in FIGS. 2A-2D. The sleep events represent incidents that may occur during one or more sleep sessions. For example, a sleep event (also referred to herein as a sleep defined event) may be a sleep interruption event or a sleep resumption event. A sleep interruption event may be indicative of a pause during a sleep session (e.g., a temporary sleep pausing event) or may be indicative of the end of a sleep session (e.g., a sleep ending event). Likewise, a sleep resumption event may be indicative of a resumption of sleep during a sleep session (e.g., a temporary sleep initiating event) or may be indicative of the beginning of a sleep session (e.g., a sleep beginning event). In other words, the sleep events in FIGS. 2A-2D depict time instances at which a user's sleep session has either began (e.g., a user has “fallen asleep”), has been interrupted temporarily (e.g., waking up temporarily during a sleep session before going back to sleep), has been resumed after being interrupted temporarily (e.g., a user falling asleep after being interrupted) or has ended (e.g., a user waking up). By analyzing the sleep data, the server 102 can determine whether or not a sleep event is indicative of a user's sleep session beginning or ending, or whether or not the sleep event is indicated to a temporary interruption/resumption of a user's sleep session. Ultimately, the server 102 can determine a starting time instance and a stopping time instance to define the sleep session and can classify the sleep session as belonging to a calendar day associated with the stopping time instance. It should be appreciated that, in one example, the sleep defined events may be detected by the server 102 based on user intervention (i.e., a user or other entity inputs or otherwise indicates to a server 102 via a monitoring device or otherwise that a sleep defined event has occurred).

Referring first to FIG. 2A, timeline 210 shows time instances of four sleep events 212(1)-212(4). The sleep events 212(1)-212(4) occur over the course of a same sleep session, shown at reference numeral 214 in FIG. 2A. The determination of the sleep session duration (e.g., in FIG. 2A lasting for the duration of time including sleep events 212(1)-212(4)) may be determined independently at a device different from the server 102. For example, the monitoring device 102 or another device (not shown in FIG. 1) may define a sleep session and may provide to the server 102 information about the time duration of the defined sleep session. In another example, the sleep session duration may be defined by the user and may be provided to the server 102.

FIG. 2A also shows in the timeline 210 a transition point indicative of a day change. The transition point is depicted at line 216. Line 216, for example, may represent midnight and may represent a transition between calendar days, and the time instances in the timeline 210 may represent traditional calendar time instances (e.g., AM/PM times). In another example, line 216 may define a transition point between “days” defined in non-traditional ways. For example, line 216 may represent any time before which sleep events are considered as occurring on a previous day (“Day n−1”) and after which sleep events are considered as occurring on a present day (“Day n”), even though in this context, the “previous day” and “present day” may occur on the same calendar day. In other words, the term “day” may be traditional calendar days and/or may be days defined in terms of pre-transition point and post-transition point times.

As stated above, in FIG. 2A, the four sleep events 212(1)-212(4) occur during the same sleep session 214. The first sleep event 212(1) indicates the beginning of the sleep session, and the last sleep event 212(4) indicates the end of the sleep session. Sleep event 212(2) and sleep event 212(3) occur during the sleep session and represent an interruption and resumption of the sleep session, respectively. It should be appreciated that the server 102 is configured with information to determine whether a sleep event constitutes an interruption of a sleep event or the termination of a sleep event. That is, the server 102 is provided (e.g., a priori or on an ad hoc basis) information as to whether a particular sleep event should indicate the start/end of a sleep session or whether a particular sleep event should be considered as occurring within a sleep session. In one example, the server 102 may first determine whether a sleep event is a sleep interruption event or a sleep resumption event, and upon making such determination, may classify the sleep interruption event as either a sleep ending event or a temporary sleep pausing event and may classify the sleep resumption event as either a sleep beginning event or a temporary sleep initiating event. For example, the server 102 may determine that the sleep resumption event is indicative of a sleep beginning event when the sleep data indicates that the sleep resumption event has occurred for longer than a predetermined period of time. Similarly, the server 102 may determine that the sleep interruption event is indicative of the sleep ending event when the sleep data indicates that the sleep interruption event has occurred for longer than a predetermined period of time. Thus, in one example, the server 102 may differentiate and classify a sleep interruption event as a sleep ending event or a temporary sleep pausing eent based on based on threshold time values (e.g., in a non-limiting example, threshold values between zero seconds and 10 minutes) during which the sleep interruption event occurs. Likewise, the server 102 may differentiate and classify a sleep resumption event as a sleep beginning event or a temporary sleep initiating event based on threshold time values (e.g., in a non-limiting example, threshold values between zero seconds and 10 minutes) during which the sleep resumption event occurs. In another example, the server 102 may be programmed (a priori or at the instruction of a network entity or user on an ad-hoc basis) with rules that define the timing of sleep events as triggering classifications to particularly sleep sessions. In one example, the server 102 may configured/programmed with rules and logic to indicate that any sleep resumption event occurring after 10:00 PM on a given calendar day automatically indicates that the sleep event will be associated with the sleep session for the next calendar day. This is merely an example, and is used demonstratively to indicate that the server 102 may use the timing of sleep events to classify and associate the sleep events as belonging to particular sleep sessions, based, for example, on rules or other classification guidelines provided to and programmed in the server 102 (e.g., as part of the sleep classification software 110).

In the example in FIG. 2A, the server 102 analyzes the sleep data including the time at which the sleep events 212(1)-212(4) occur relative to the transition point on the timeline 210. In one example, the server 102 determines calendar time instances (e.g., “calendar times” or “traditional times”) associated with each of the sleep events 212(1)-212(4). The server 102 determines that if the sleep event indicating an ending of a sleep session occurs after the transition point, the entire sleep session will be categorized as occurring on the day on which the sleep session ends. Thus, in FIG. 2A, since the sleep session 214 ends at a time after the transition point, the server 102 categorizes the entire sleep session as occurring on day “n,” even though the sleep session began on day “n−1” (as indicated by sleep event 212(1) occurring before the transition point). Furthermore, the sleep session 214 ends on day “n” even though there was a temporary sleep pausing event 212(2) in day “n−1.” That is, since sleep interruption event 212(2) was not a sleep ending event, the server 102 does not use the time instance of sleep interruption event 212(2) to classify the day of the sleep session 214, and instead, the server 102 classifies the sleep session 214 on day “n,” when the sleep ending event 212(4) occurs. Thus, the server 102 classifies the sleep session in day “n.” As stated above, day “n” may be a calendar day or may be a day defined in another non-traditional way.

Referring to FIG. 2B, timeline 220 shows four sleep events 222(1)-222(4). The four sleep events 222(1)-222(4) occur during the same sleep session, as shown by reference numeral 224 in FIG. 2B. FIG. 2B also shows, at line 226, the transition point defining the time boundary between day “n−1” and day “n.” In FIG. 2B, the server 102 determines that the sleep session ends at a time after the transition point 226, and thus categorizes the entire sleep session as occurring on day “n−1,” even though the sleep session begins on day “n.” Accordingly, the server 102 classifies the sleep session in day “n.” It should be appreciated that the server 102 makes this determination based on the sleep ending event 222(4), and not based on the sleep interruption event 222(2) or the sleep resumption event 222(3), even though those events also happen in day “n.”

In FIG. 2C, timeline 230 shows four sleep events 232(1)-232(4). Sleep events 232(1) and 232(2) pertain to a sleep starting event and a sleep ending event, respectively, for sleep session A. Thus, the server 102 classifies sleep session A as occurring on the day in which the sleep ending event for sleep session A occurs (i.e., day “n−1”). Likewise, sleep events 232(3) and 232(4) pertain to a sleep starting event and a sleep ending event, respectively, for sleep session B. Thus, the server 102 classifies sleep session B as occurring on the day in which the sleep ending event for sleep session B occurs (i.e., day “n”). FIG. 2C also shows, at line 236, the transition point represents the time boundary between day “n−1” and day “n.”

As stated above, the server 102 categorizes and classifies the entirety of each sleep session as occurring on the day on which the particular sleep session ends. In FIG. 2C, there are two sleep sessions: sleep session A and sleep session B. Thus, the server 102 categorizes and classifies sleep session A and sleep session B in different instances. For example, the server 102 determines that sleep session A ends at a time in day “n−1” and thus categorizes the entire sleep session A as occurring on day “n−1.” Analogously, the server 102 determines that sleep session B ends at a time in day “n” and thus categorizes the entire sleep session B as occurring on day “n.” It so happens that the start of sleep session A and sleep session B occur at a time in the same day on which the respective sleep sessions end, but it should be appreciated that, as stated above, the server 102 categorizes the entire sleep session based on the day on which the session ends, regardless of the start time of the sleep session. Thus, in the examples in FIGS. 2A and 2B, the sleep sessions 214 and 224, respectively, are classified entirely as occurring on day “n” even though each of these sleep session began on day “n−1.” In other words, for a given sleep session, the sleep ending event may occur at a time that corresponds to a calendar day that is different from the calendar day on which the sleep session began, but regardless, the entire sleep session may be classified as belonging only to the calendar day on which the sleep session ends.

FIG. 2D shows timeline 240 with five sleep events 242(1)-242(5). Sleep events 242(1) and 242(2) represent the sleep beginning event and sleeping ending event, respectively, for sleep session C (shown at reference numeral 244(c)). Sleep events 242(3) and 242(5) represent the sleep beginning event and the sleep ending event, respectively, for sleep session D (shown at reference numeral 244(d)), and sleep event 242(4) represents a sleep pausing event.

FIG. 2D shows two transition points, one at line 246 that represents the time boundary between day “n−1” and day “n” and one at line 248 that defines the time boundary between day “n” and day “n+1.” Sleep session C begins on day “n−1” and ends on day “n,” and thus, the server 102 categorizes and classifies the entire sleep session C as occurring on day “n.” Sleep session D begins on day “n” and ends on day “n+1” (with sleep pausing event 242(4) occurring on day “n”). Thus, the server 102 categorizes and classifies the entire sleep session D as occurring on day “n+1” since sleep session D ends on day “n+1.”

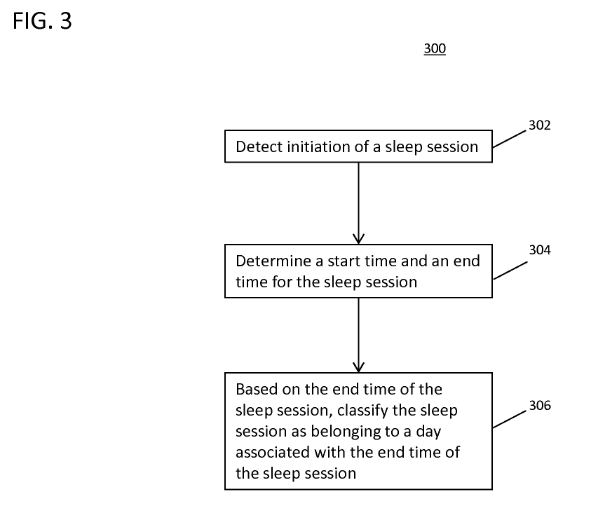

Reference is now made to a FIG. 3. FIG. 3 shows an example flow chart 300 depicting operations of the server 102 classifying sleep data. At operation 302, the server 102 detects an initiation of a sleep session. As stated above, the server 102 may detect the initiation of the sleep session based on information provided to the server 102 (e.g., indicating the beginning of a sleep session). At operation 304, the server 102 determines a start time and an end time for the sleep session, and at 306, the server 102 classifies the sleep session as belonging to a day associated with the end time of the sleep session. The server 102 performs this classification based on, for example, the end time of the sleep session.

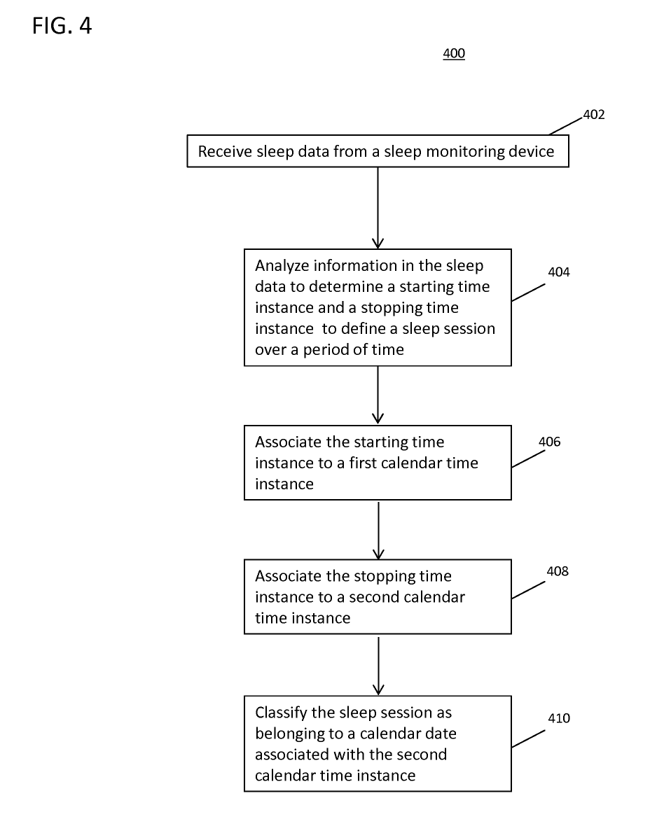

Reference is now made to FIG. 4, which shows another example flow chart 400 depicting operations of the server 102 classifying the sleep data. At operation 402, the server 102 receives from a sleep monitoring device over a network sleep data. The sleep data comprises information that is indicative of sleep patterns of a user over a period of time. The server 102, at operation 404, analyzes the information to determine a starting time instance and a stopping time instance to define a sleep session over the period of time. At 406, the server 102 associates the starting time instance to a first calendar time instance and at 408 associates the stopping time instance to a second calendar time instance. At operation 410, the server 102 classifies the sleep session as belonging to a calendar date associated with the second calendar time instance.

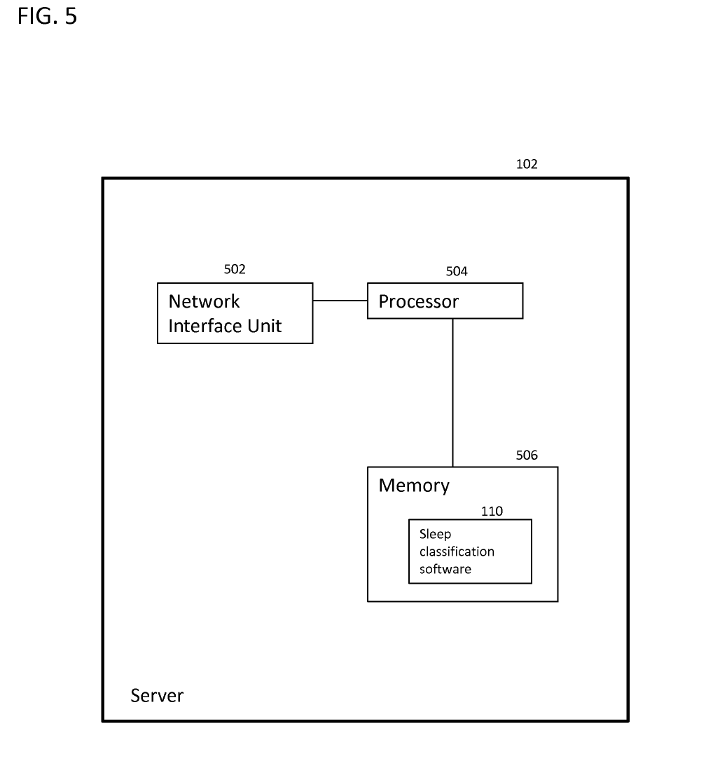

Reference is made to FIG. 5. FIG. 5 shows an example block diagram 102 of the server. The server 102 is configured to classify sleep session data, as described by the techniques herein. The server 102 has a network interface unit 502, a processor 504 and a memory 506. The network interface unit 502 is configured to send and receive communications to and from devices in the system 100 (e.g., the monitoring device 104 and the display device 106). For example, the network interface unit 502 receives sleep session data from the network devices and sends display instructions to the network devices. The network interface unit 502 is coupled to the processor 504. The processor 504 is, for example, a microprocessor or microcontroller that is configured to execute program logic instructions (i.e., software) for carrying out various operations and tasks of the server 102, as described above. For example, the processor 504 is configured to execute sleep classification software 110 according to the techniques described above. The functions of the processor 504 may be implemented by logic encoded in one or more tangible computer readable storage media or devices (e.g., storage devices, compact discs, digital video discs, flash memory drives, etc. and embedded logic such as an application specific integrated circuit, digital signal processor instructions, software that is executed by a processor, etc.)

The memory 506 may comprise read only memory (ROM), random access memory (RAM), magnetic disk storage media devices, optical storage media devices, flash memory devices, electrical, optical, or other physical/tangible (non-transitory) memory storage devices. The memory 506 stores software instructions for the sleep classification software 110.

The sleep classification software 110 may take any of a variety of forms, so as to be encoded in one or more tangible computer readable memory media or storage device for execution, such as fixed logic or programmable logic (e.g., software/computer instructions executed by a processor), and the processor 502 may be an application specific integrated circuit (ASIC) that comprises fixed digital logic or a combination thereof.

For example, the processor 504 may be embodied by digital logic gates in a fixed or programmable digital logic integrated circuit, which digital logic gates are configured to perform the sleep classification software 110. In general, the sleep classification software 110 may be embodied in one or more computer readable storage media encoded with software comprising computer executable instructions and when the software is executed operable to perform the operations described herein.

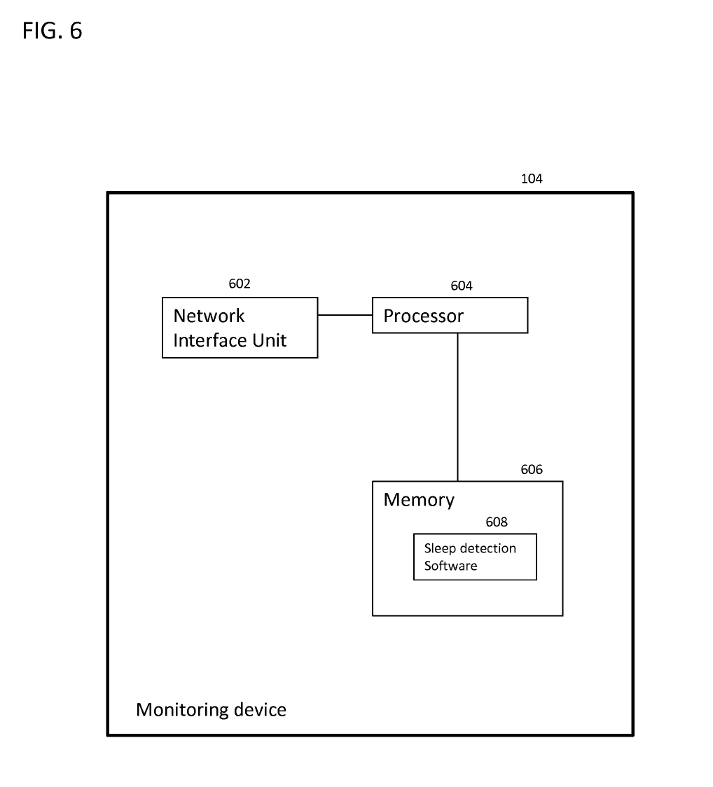

Reference is now made to FIG. 6. FIG. 5 shows a block diagram 104 of the monitoring device. The monitoring device 104 comprises a network interface unit 602, a processor 604 and a memory 606. The network interface unit 602, processor 604 and memory 606 operate in a substantially similar manner as the network interface unit 502, processor 504 and memory 506 described in connection with FIG. 5, above. In FIG. 6, the memory 606 stores sleep detection software 608, which, when executed by the processor 606, causes the monitoring device 104 to detect a sleep session and to collect sleep session data.

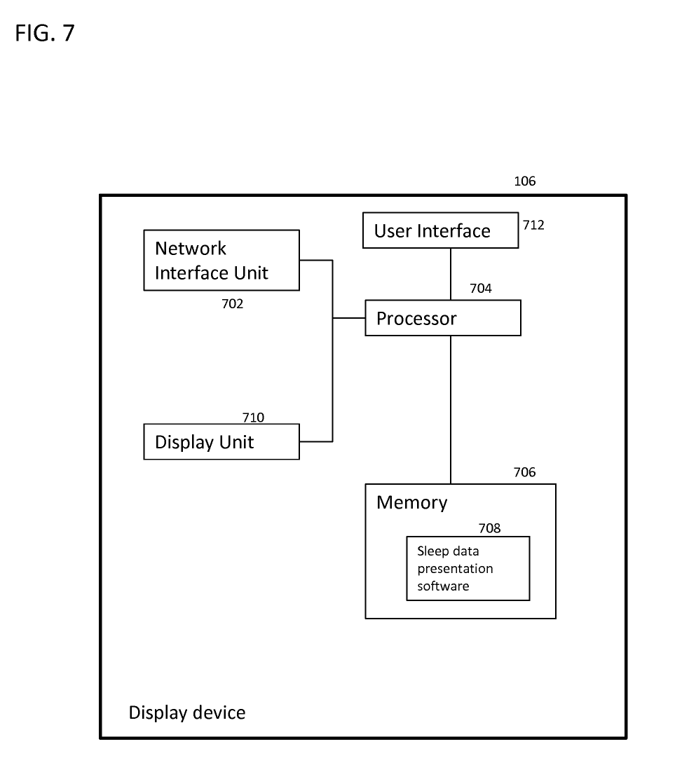

Reference is now made to FIG. 7. FIG. 7 shows a block diagram 106 of the display device. The display device 106 comprises a network interface unit 702, a processor 704 and a memory 706. The network interface unit 702, processor 704 and memory 706 operate in a substantially similar manner as the network interface unit 502, processor 504 and memory 506 described in connection with FIG. 5, above. In FIG. 7, the memory 706 stores sleep data presentation software 708, which, when executed by the processor 704, causes the display device 106 to present (e.g., to a user) sleep data. For example, the display device 106 may present to the user sleep data associated with a user's sessions over the course of a particular time period (e.g., a day, month, year, etc.). FIG. 7 also shows a display unit 710 and a user interface 712. The display unit 710 may be any component of the display device 106 (e.g., screen) configured to display data to a user. The user interface 712 may be any component of the display device 106 configured to receive input from a user. For example, the user interface 712 may be a keyboard, mouse, touch screen, audio and/or video input received from the user.

In summary, a method is described for analyzing sleep data. The method comprises: at a server device, receiving from a sleep monitoring device over a network sleep data, wherein the sleep data comprises information that is indicative of sleep patterns of a user over a period of time; after receiving the sleep data, analyzing the information to determine a starting time instance and a stopping time instance to define a sleep session over the period of time; associating the starting time instance to a first calendar time instance; associating the stopping time instance to a second calendar time instance; and classifying the sleep session as belonging to a calendar day associated with the second calendar time instance.

In addition, one or more computer readable storage media is provided that is encoded with software comprising computer executable instructions and when the software is executed operable to: receive sleep data over a network from a sleep monitoring device, wherein the sleep data comprises information that is indicative of sleep patterns of a user over a period of time; analyze the information to determine a starting time instance and a stopping time instance to define a sleep session over the period of time; associate the starting time instance to a first calendar time instance; associate the stopping time instance to a second calendar time instance; and classify the sleep session as belonging to a calendar day associated with the second calendar time instance.

Furthermore, an apparatus is provided comprising: a network interface unit; and a processor unit coupled to the network interface unit and configured to: receive via the network interface unit sleep data over a network from a sleep monitoring device, wherein the sleep data comprises information that is indicative of sleep patterns of a user over a period of time; analyze the information to determine a starting time instance and a stopping time instance to define a sleep session over the period of time; associate the starting time instance to a first calendar time instance; associate the stopping time instance to a second calendar time instance; and classify the sleep session as belonging to a calendar day associated with the second calendar time instance.

The above description is intended by way of example only. Various modifications and structural changes may be made therein without departing from the scope of the concepts described herein and within the scope and range of equivalents of the claims.

It should be appreciated that the techniques described above in connection with all of the embodiments may be performed by one or more computer readable storage media that is encoded with software comprising computer executable instructions to perform the methods, operations and steps described herein. For example, the operations performed by the server 102 may be performed by one or more computer or machine readable storage media (non-transitory) or device executed by a processor and comprising software, hardware or a combination of software and hardware to perform the techniques described herein. Thus, it is intended that the present embodiments covers the modifications and variations of this invention provided they come within the scope of the claims and their equivalents.

What is claimed is:

1. A method for analyzing sleep data, the method comprising:
at a server device, receiving from a sleep monitoring device over a network sleep data, wherein the sleep data comprises information that is indicative of sleep patterns of a user over a period of time;
after receiving the sleep data, analyzing the information to determine a starting time instance and a stopping time instance to define a sleep session over the period of time;
associating the starting time instance to a first calendar time instance;
associating the stopping time instance to a second calendar time instance; and
classifying the sleep session as belonging to a calendar day associated with the second calendar time instance.

2. The method of claim 1, further comprising:
after receiving the sleep data, analyzing the information to identify one or more sleep defined events, wherein the sleep defined events include one or more of a sleep interruption event and a sleep resumption event;
when a sleep interruption event is identified, determining whether the sleep interruption event is indicative of a sleep ending event or whether the sleep interruption event is indicative of a temporary sleep pausing event; and
when a sleep resumption event is identified, determining whether the sleep resumption event is indicative of a sleep beginning event or whether the sleep resumption event is indicative of a temporary sleep initiating event.

3. The method of claim 2, further comprising:
when the sleep resumption event is determined to be indicative of the sleep beginning event:
classifying the sleep resumption event as a sleep session start event; and
associating the starting time instance with the sleep session start event; and
when the sleep interruption event is determined to be indicative of the sleep ending event:
classifying the sleep interruption event as a sleep session stop event; and
associating the stopping time instance with the sleep session stop event.

4. The method of claim 2, wherein determining whether the sleep interruption event is indicative of the sleep ending event comprises determining that the sleep interruption event is indicative of the sleep ending event when the sleep data indicates that the sleep interruption event has occurred for longer than a predetermined period of time.

5. The method of claim 2, wherein determining whether the sleep resumption event is indicative of the sleep beginning event comprises determining that the sleep resumption event is indicative of the sleep beginning event when the sleep data indicates that the sleep resumption event has occurred for longer than a predetermined period of time.

6. The method of claim 1, wherein classifying comprises classifying the sleep session as belonging to the calendar day that is associated with both the first calendar time instance and the second calendar time instance.

7. The method of claim 1, wherein classifying comprises classifying the entire sleep session as belonging to the calendar day that is associated with the second calendar time instance only even if the first calendar time instance is associated with a different calendar day.

8. One or more computer readable storage media encoded with software comprising computer executable instructions and when the software is executed operable to:
receive sleep data over a network from a sleep monitoring device, wherein the sleep data comprises information that is indicative of sleep patterns of a user over a period of time;
analyze the information to determine a starting time instance and a stopping time instance to define a sleep session over the period of time;
associate the starting time instance to a first calendar time instance;
associate the stopping time instance to a second calendar time instance; and
classify the sleep session as belonging to a calendar day associated with the second calendar time instance.

9. The computer readable storage media of claim 8, further comprising instructions operable to:
analyze the information to identify one or more sleep defined events, wherein the sleep defined events include one or more of a sleep interruption event and a sleep resumption event;
determine, when a sleep interruption event is identified, whether the sleep interruption event is indicative of a sleep ending event or whether the sleep interruption event is indicative of a temporary sleep pausing event; and
determine, when a sleep resumption event is identified, whether the sleep resumption event is indicative of a sleep beginning event or whether the sleep resumption event is indicative of a temporary sleep initiating event.

10. The computer readable medium of claim 9, further comprising instructions operable to:
classify the sleep resumption event as a sleep session start event and associate the starting time instance with the sleep session start event when the sleep resumption event is determined to be indicative of the sleep beginning event; and
classify the sleep interruption event as a sleep session stop event and associate the stopping time instance with the sleep session stop event when the sleep interruption event is determined to be indicative of the sleep ending event.

11. The computer readable medium of claim 9, wherein the instructions operable to determine whether the sleep interruption event is indicative of the sleep ending event comprise instructions operable to determine that the sleep interruption event is indicative of the sleep ending event when the sleep data indicates that the sleep interruption event has occurred for longer than a predetermined period of time.

12. The computer readable medium of claim 9, wherein the instructions operable to determine whether the sleep resumption event is indicative of the sleep beginning event comprise instructions operable to determine that the sleep resumption event is indicative of the sleep beginning event when the sleep data indicates that the sleep resumption event has occurred for longer than a predetermined period of time.

13. The computer readable medium of claim 8, wherein the instructions operable to classify the sleep session comprise instructions operable to classify the sleep session as belonging to the calendar day that is associated with both the first calendar time instance and the second calendar time instance.

14. The computer readable medium of claim 8, wherein the instructions operable to classify the sleep session comprise instructions operable to classify the entire sleep session as belonging to the calendar day that is associated with the second calendar time instance only even if the first calendar time instance is associated with a different calendar day.

15. An apparatus comprising:
a network interface unit; and
a processor unit coupled to the network interface unit and configured to:
receive via the network interface unit sleep data over a network from a sleep monitoring device, wherein the sleep data comprises information that is indicative of sleep patterns of a user over a period of time;
analyze the information to determine a starting time instance and a stopping time instance to define a sleep session over the period of time;
associate the starting time instance to a first calendar time instance;
associate the stopping time instance to a second calendar time instance; and
classify the sleep session as belonging to a calendar day associated with the second calendar time instance.

16. The apparatus of claim 15, wherein the processor is further configured to:
analyze the information to identify one or more sleep defined events, wherein the sleep defined events include one or more of a sleep interruption event and a sleep resumption event;
determine, when a sleep interruption event is identified, whether the sleep interruption event is indicative of a sleep ending event or whether the sleep interruption event is indicative of a temporary sleep pausing event; and
determine, when a sleep resumption event is identified, whether the sleep resumption event is indicative of a sleep beginning event or whether the sleep resumption event is indicative of a temporary sleep initiating event.

17. The apparatus of claim 16, wherein the processor is further configured to:
classify the sleep resumption event as a sleep session start event and associate the starting time instance with the sleep session start event when the sleep resumption event is determined to be indicative of the sleep beginning event; and
classify the sleep interruption event as a sleep session stop event and associate the stopping time instance with the sleep session stop event when the sleep interruption event is determined to be indicative of the sleep ending event.

18. The apparatus of claim 16, wherein the processor is further configured to determine that the sleep interruption event is indicative of the sleep ending event when the sleep data indicates that the sleep interruption event has occurred for longer than a predetermined period of time.

19. The apparatus of claim 16, wherein the processor is further configured to determine that the sleep resumption event is indicative of the sleep beginning event when the sleep data indicates that the sleep resumption event has occurred for longer than a predetermined period of time.

20. The apparatus of claim 15, wherein the processor is further configured to classify the sleep session as belonging to the calendar day that is associated with both the first calendar time instance and the second calendar time instance.
